(19) United States
(12) Patent Application Publication
(10) Pub. No.: US 2023/0389488 A1
(43) Pub. Date: Dec. 7, 2023

(54) DEVICE AND METHOD FOR INTRODUCING SEEDS OR SEEDLINGS INTO A SUBSTRATE CORD, HAVING A SUBSTRATE CORD COVERED WITH A SHEATH, AND SYSTEM FOR CULTIVATING PLANTS WITH A SUBSTRATE CORD

(71) Applicant: Jochen Friedrich HAUBNER, Nuernberg (DE)

(72) Inventor: Jochen Friedrich HAUBNER, Nuernberg (DE)

(21) Appl. No.: 18/213,655

(22) Filed: Jun. 23, 2023

Related U.S. Application Data
(63) Continuation of application No. PCT/EP2021/087609, filed on Dec. 23, 2021.

(30) Foreign Application Priority Data
Dec. 24, 2020 (DE) 10 2020 134 937.8

(51) Int. Cl. A01G 24/40; A01G 24/60

(52) U.S. Cl. CPC A01G 24/40; A01G 24/60

(57) ABSTRACT

A device and a method for introducing seeds or seedlings into a substrate strand, and to a substrate strand encased by a sheath, and to a system for cultivating plants using a substrate strand. The substrate strand is enclosed by a sheath, and the space enveloped by the sheath is filled with a plant substrate. Openings are introduced into the sheath at a predetermined point, through which openings the seeds or seedlings are inserted into the plant substrate. The advantage of the invention lies in substantial automation of these operations in order to increase the efficiency and cost-effectiveness.

This nonprovisional application is a continuation of International Application No. PCT/EP2021/087609, which was filed on Dec. 23, 2021, and which claims priority to German Patent Application No. 10 2020 134 937.8, which was filed in Germany on Dec. 24, 2020, and which are both herein incorporated by reference.

### BACKGROUND OF THE INVENTION

### Field of the Invention

The present invention relates to a device for introducing seeds and seedlings into a tube-like substrate cord encased by a sheath, a method for introducing seeds and seedlings into a tube-like substrate cord encased by a sheath, a substrate cord 29, and a system for cultivating plants using a substrate cord.

### Description of the Background Art

The planting of plant cultures for cultivating agricultural and ornamental plants involves a considerable amount of manual labor, which from an economic viewpoint is disadvantageous, in particular in large-area planting. Therefore, in the past there has been no lack of effort to reduce the amount of manual labor, by the use of machines and intensifying preproduction.

Thus, for example, a device for manufacturing a seed carrier is known from U.S. Pat. No. 3,456,386, the device comprising essentially a cylindrical sheath that is filled with a plant substrate. A twisted band to which seeds adhere extends in the core region of the plant substrate. For manufacturing the seed carrier, the band together with the seeds and the strip-shaped sheath are initially combined in a continuous process and then filled with plant substrate, in a specialized device. To form a cylindrical continuous cord, the longitudinal edges of the sheath are subsequently folded inwardly and adhered to one another in the overlap region. Clocked cutting to length of the continuous cord results in cylindrical seed carriers having a predetermined length.

The band that is used, with adhering seeds, results from an adhesive-impregnated yarn that is led through a storage hopper containing seeds, with the seeds sticking to the yarn. It has proven to be disadvantageous that an undefinable number of seeds adhere per unit length of the yarn, and the number of seeds per unit length may thus be only approximately determined within rough limits.

Furthermore, a method and a device for producing plant stumps are known from DE 34 30 563 A1, wherein a plant substrate from a storage hopper is spread out to form a thin fleece, and then reshaped into a continuous cylindrical substrate cord in a cord former. Individual seeds are laid onto the continuous substrate cord with the aid of a feed device, and both are encased by a sheath material strip before the individual plant stumps are obtained in a cutting device by cutting the encased continuous substrate cord to length. The time period from depositing the seeds until the continuous substrate cord is closed by the sheath has proven to be problematic, since the seeds only lie loosely on the substrate, resulting in the risk that they may fall from the side of the cord.

### SUMMARY OF THE INVENTION

It is therefore an object of the present invention to eliminate the disadvantages known from the prior art. A further object of the invention is to provide the cultivation of plants in the most cost-effective manner possible.

In a first aspect of the invention, in contrast to the prior art, the seeds or seedlings are not introduced onto or into the plant substrate of the substrate cord until after the sheath is applied. For this purpose, according to the invention it is provided that the sheath is provided with an opening at a predetermined location, i.e., with uniform or variable spacing, and one or more seeds or seedlings are subsequently inserted into the plant substrate through the opening.

One of the resulting advantages is that the seedling no longer has to penetrate the sheath in the course of growth, and the plants may thus develop better and more quickly.

Furthermore, it has proven to be advantageous that according to the invention, a seed or a seedling may be introduced into the substrate cord, using the deposition device, at a depth that is adapted to the particular intended purpose, so that optimal boundary conditions for the germination and plant growth may be created.

After the seed is introduced, the opening or indentation may optionally be closed off with suitable materials, for example sand, perlite, vermiculite, hydromulch, and the like, in order to coordinate the characteristics of the substrate in the immediate vicinity of the seed to the requirements of the seed and seedling in a targeted manner.

For creating an opening in the sheath, according to the invention a perforation device is provided, the perforation tool of which is lowerable onto the substrate cord transversely with respect to the axis of the substrate cord, thereby opening the sheath. For this purpose, the perforation device may have a stationary guide, along which a tool carrier with a perforation tool, actuated by an actuator, may be moved. It would also be possible for the perforation tool to be situated at a driven swivel arm that is designed to be swivelable about a stationary pivot bearing at the perforation device, or for the perforation tool to rest at the end of an electronically controlled robotic arm that performs the lowering movement. Therefore, the term “lowerable” is not limited to a linear movement, but, rather, encompasses all possible movements that result in the perforation tool being able to move from a position remote from the sheath into a position that touches or penetrates the sheath.

The same applies for the deposition device according to the invention, including a deposition tool, provided that the deposition tool is designed to be transaxially lowerable onto the substrate cord, and/or for the cover according to the invention for closing the opening or the indentation in the substrate cord, and/or for the pressing element according to the invention, which is lowerable onto the opening or indentation in the substrate cord loaded with a seed.

The substrate cord, which is produced in a clocked or continuous manner, is supplied to an apparatus for cutting to length and separation. At that location, the continuously produced substrate cord is divided into ready-to-use substrate cord sections and simultaneously deposited into receiving elements. Suitable receiving elements may be gutters into which the substrate cords are inserted, or also reels onto which the substrate cords are rolled.

Inserting the substrate cords into gutter-shaped receiving elements and cutting them to length and separating them advantageously takes place with the aid of a control unit that controls the relative movements between a laying head, with a laying head end, and the receiving elements. In one preferred embodiment of the invention, at least the laying head and preferably also the laying head end are situated stationarily with respect to the device, in particular in a linear extension of the conveying device, and the receiving elements have a displaceable design. In this way, the apparatus for depositing and separating may be optimally integrated into the rest of the device according to the invention and the subsequent processing operations, for example transfer, storage, and transport of the finished receiving elements.

Alternatively, it is possible for the laying head end or the laying head end together with the laying head to have a movable design for depositing the substrate cord into the receiving units. The receiving units may be situated stationarily with respect to the device, or also movably situated In particular for receiving units having a very large longitudinal extension and/or receiving elements that are combined to form larger units, complicated handling using the receiving units during the deposition and separation is thus dispensed with.

In a system according to the invention, a substrate cord including a sheath, plant substrate, and seeds or plants is arranged in a gutter, it being possible to supply the gutter with water for irrigation. In this system it has proven to be advantageous for a plurality of substrate cords to be producible and storable, in particular temporally and spatially independently of the gutters into which they are subsequently inserted. Filling the gutters is thus reduced to merely inserting the substrate cords into the gutters. Producing the substrate cords and also inserting them into the gutters take place for the most part automatically, which significantly reduces the amount of manual labor and thus speeds up processes tremendously. The process up to the completely planted cultivation gutter may thus take place extremely efficiently and cost-effectively.

The sheath of the substrate cord clearly and continuously delimits the region of the plant substrate from the remaining gutter cross section, which is available as a flow cross section for the water, for example during the watering and drainage of the gutter. This prevents plant substrate from being washed out of the substrate cord in the growth phase of the plants. As a result of the invention, refilling plant substrate to compensate for the washed-out quantity is no longer necessary. At the same time, this eliminates the risk of the plant substrate constricting or blocking the flow cross section for water, resulting in water damming up or the gutter overflowing at an undesirable location, or of the irrigation system clogging downstream from the gutter due to washed-out plant substrate.

After the plants are harvested, the plant substrate may be removed and optionally recovered simply by withdrawing the substrate cord from the gutter. This procedure is thus very easy and quick, and in turn allows the use of mechanical aids. There are practically no remaining substrate residues in the gutter, which greatly facilitates cleaning of the gutters before reuse, and may even make cleaning totally unnecessary.

In examples of the system according to the invention in which the incidence of light into the gutter is prevented or at least reduced by the substrate cord and/or gutter elements, undesirable algae growth in the gutter is prevented, thus reducing maintenance and cleaning operations.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an oblique view of a device according to the invention, the conveying device being formed by a roller conveyor with advancer in the form of a pair of rollers,

FIG. 2 shows a top view of the device illustrated in FIG. 1,

FIG. 3 shows a section, in enlarged scale, through the device illustrated in FIG. 2, along the line III-Ill in that figure,

FIG. 4 shows a section, in enlarged scale, through the device illustrated in FIG. 2, along the line IV-IV in that figure,

FIG. 5 shows a section, in enlarged scale, through the device illustrated in FIG. 2, along the line V-V in that figure,

FIG. 6 shows an oblique view of a device according to the invention, in which the conveying device is formed by an endless conveyor belt,

FIG. 7 shows an oblique view of a device according to the invention, the conveying device being formed by a stationary conveyor channel with an advancer in the form of a feed roller and a pressing roller,

FIG. 8 shows an oblique view of a device according to the invention, the conveying device being formed by a stationary conveyor channel with advancer in the form of a gripper,

FIG. 9 shows an oblique view of an apparatus for cutting the substrate cord to length and separating the cut-to-length substrate cord sections,

FIG. 10 shows an oblique view of an apparatus for cutting the substrate cord to length and separating the cut-to-length substrate cord sections,

FIG. 11 shows an oblique view of an apparatus for cutting the substrate cord to length and separating the cut-to-length substrate cord sections,

FIG. 12 shows an oblique view of an apparatus for cutting the substrate cord to length and separating the cut-to-length substrate cord sections,

FIG. 13 shows an oblique view of a system according to the invention, including a substrate cord and gutter,

FIGS. 14A to 14C, in each case, show a cross section of further examples of a system according to the invention,

FIG. 15 shows a cross section of a system according to the invention, including one gutter and two substrate cords,

FIG. 16 shows a cross section of a system according to the invention, including two gutters and two substrate cords, and

FIG. 17 shows a cross section of a system according to the invention, including one gutter having a V-shaped cross section and one substrate cord.

### DETAILED DESCRIPTION

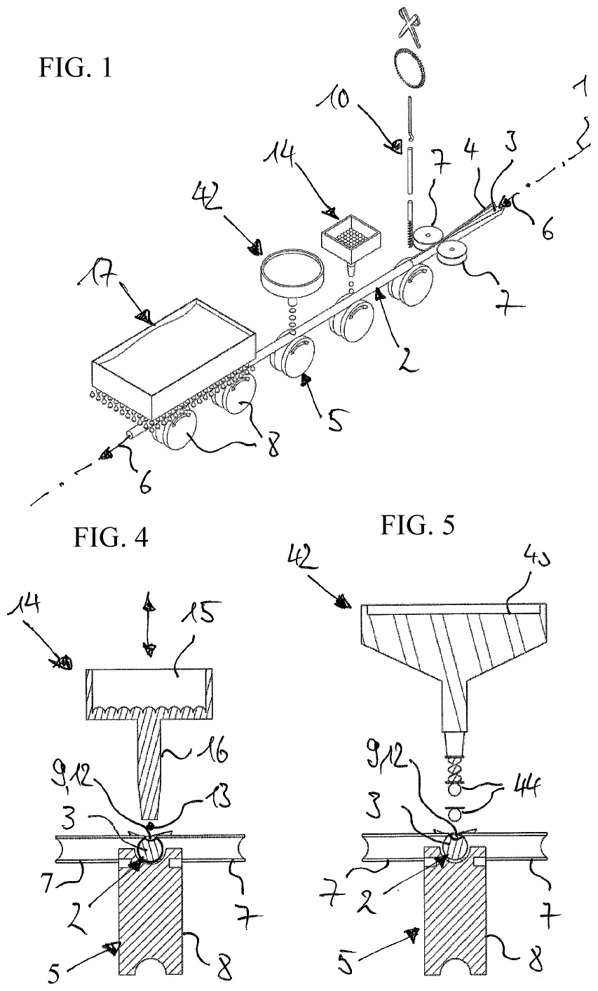

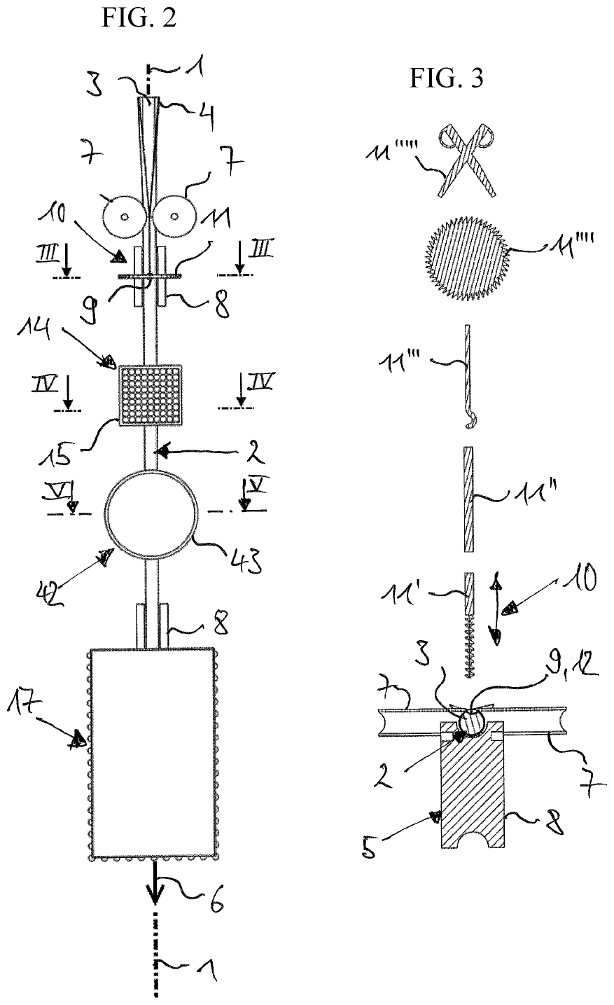

FIGS. 1 and 2 show, in a schematic illustration, an overview of a device according to the invention, to which a substrate cord 2 is continuously supplied along an axis 1. The longitudinal axis of the substrate cord 2 thus corresponds to the axis 1. The substrate cord 2 is made up essentially of a plant substrate 3, which in preceding work steps has been formed into a continuous cord and encased by a cylindrical sheath 4. The plant substrate may be composed, for example, of suitable mixtures of compost, humus, clay, sand, white peat, black peat, lime, and the like. The substrate cord 2 is moved in the direction of the arrows 6 with the aid of a conveying device 5, and successively passes through various processing stations.

The conveying device 5 has at least one pair of rollers 7, whose rollers opposite its outer circumference are driven in the opposite direction. The circumferential surfaces of the rollers, which may have a concave design for accommodating the substrate cord 2, rest against the sheath 4 under sufficient pressure in order to transfer a feed force to the substrate cord 2 via frictional engagement. The substrate cord 2, driven in this way, moves on guide rollers 8 situated along the axis 1; the guide rollers with their likewise concavely designed circumferential surfaces form a roller conveyor or guide channel that extends coaxially with respect to the axis 1. The guide rollers 8 may also be driven with a uniform direction of rotation.

The first processing station is used to create an opening 9 in the sheath 4. For this purpose, the device according to the invention has a perforation device 10, illustrated in enlarged scale in FIG. 3. Once again, the substrate cord 2 that is driven by the pair of rollers 7 and that rests on the guide rollers 8 is apparent here. For the perforation device 10, different types of perforation tools 11 are illustrated, which may be inserted into the perforation device 10 and used for creating the opening 9, depending on the intended purpose. The selected perforation tool 11 is clamped into a tool carrier, not illustrated in greater detail, that is coupled to a drive, which, as symbolized by the double arrow, bring about a lowering of the tool carrier together with the perforation tool 11 onto the substrate cord 2, and subsequent raising. The lowering or raising movement may take place linearly and/or as a swivel motion.

In a first embodiment of the invention, the perforation tool 11 includes a rotating borer 11′ that is lowerable onto the substrate cord 2 perpendicularly with respect to the axis 1. In the course of lowering, the borer 11′ bores through the sheath 4 and thus creates an opening 9 in the sheath, and optionally an indentation 12 in the plant substrate 3 if the borer 11′ is lowered further. The size of the opening 9 and optionally the dimensions of the indentation 12 may be determined by the selection of a borer 11′ having a suitable diameter.

Alternatively, the perforation tool 11 may be made up of a punching knife 11″, which with a short cycle time easily creates an opening 9. For example, a suitable punching knife 11″ has a cutting edge or two or more cross cutting edges in order to create a single slot or a cross slot as the opening 9. The cutting edge of the punching knife 11″ may also optionally extend in a circular, oval, or polygonal manner in order to create openings 9 in the sheath 4 having an appropriate contour. It is possible for the cutting edge to have sections over its length which protrude in the lowering direction with respect to neighboring sections, and which therefore penetrate the sheath 4 earlier, which is the case, for example, for an undulated or zigzagged profile of the cutting edge. Alternatively or additionally, the punching knife 11″ may also be part of a wheel or a roller, at the outer circumference of which one or more punching knives 11″ are situated, so that during rolling on the sheath 4, openings 9 are created due to penetration of the punching knife 11″.

A further option for creating an opening 9 is to design the perforation tool 11 as a ripping tool 11′″ whose free end has a pointed or sickle-shaped ripping hook which penetrates into the sheath 4 from the top or the side, and which upon returning from the substrate cord 2 rips open the sheath 4 in a punctiform manner, thus creating an opening 9. Alternatively, a ripping tool according to the invention may also have multiple spikes that penetrate the sheath at narrow intervals, and ripping open takes place by subsequent spreading apart of the spikes. A ripping tool 11′″ is characterized by its robustness with low wear.

In another example of the invention, the perforation tool 11 is formed by a sawing tool 11″, for example a rotating circular knife, which in the course of the lowering makes a cut in the sheath 4, transverse to the axis 2, and due to the curvature of the circular knife simultaneously leaves an indentation in the plant substrate 3. A rapid saw stroke or a high rotational speed of the sawing tool 11″″ results in a slotted opening 9 with a clean edge and a defined depth.

Another example according to the invention provides a perforation tool 11 with a cutting edge 11′″″ that cooperates with a counter cutting edge in order to cut an opening 9 in the sheath 4. The cutting edge 11′″″ and the counter cutting edge may have a scissor-like design, resulting in a single slot as the opening 9. Alternatively, the cutting edge 11′″″ and counter cutting edge may also extend convexly or polygonally toward the substrate cord 2 in order to create a flat opening 9 with an indentation 12 adjoining therebelow. Openings 9 having different geometries may thus be created within a brief cycle time.

The processing station which follows in the conveying direction 6 is used to deposit a seed 13 through the opening 9 and onto the plant substrate 3 or into the indentation 12 below the opening 9. A deposition device 14 that is suitable for this purpose is the subject matter of FIG. 4, and includes a container 15 in which a plurality of seeds 13 are stocked. By means of a separation and metering device, not illustrated in greater detail, individual seeds 13 are supplied to a deposition tool 16, for example having a deposition tube, that introduces one or more seeds 13 into the plant substrate 3 through each opening 9 in a targeted manner. For this purpose, the deposition tool 16 may also be designed to be lowerable onto the substrate cord 2, it being possible for the free end of the deposition tool 16 to penetrate into the plant substrate 3 in order to position the seeds 13 deeper in the plant substrate 3. For this purpose, the deposition tool 16 may be clamped in a tool carrier, not illustrated in greater detail, which is coupled to a drive for lowering and raising corresponding to the double arrow. The lowering or raising movement may take place linearly and/or as a swivel motion. As a result, a defined number of seeds per unit length are deposited on the substrate cord, which ultimately also determines the spacing of the plants to be cultivated in the substrate cord.

The deposition operation may be speeded up and improved when the movement of the individual seeds 13 in the deposition tool 16 is assisted, for example pneumatically via a compressed air pulse or a lowerable plunger in the deposition tool 16.

If the seeds 13, after passing through the deposition device 14, are to penetrate deeper into the plant substrate 3 or the plant substrate 3 is to be compressed, a pressing element 18 (FIG. 7) may then be provided downstream from the deposition device 14, the pressing element applying a transaxially directed pressure force to the substrate cord 2 in the region of the opening 9. The pressing element 18 may be embodied, for example, by a compression die that is movable back and forth, or as illustrated in FIG. 7, by a roller that rolls on the substrate cord 2 with pressure. The roller may at the same time be part of the conveying device 5. For carrying out a movement of the pressing element 18 to generate a pressure force, the pressing element 18 has suitable means, for example swivel guides or linear guides, actuators, load weights, and the like.

In an optional processing station 42, it is provided to reclose the opening 9 and/or the indentation 12 in the substrate cord 2 after a seed 13 is inserted. The seed 13 is thus fixed in position, and the seed 13 is prevented from falling from the opening 9 or indentation 12. Devices suitable for this purpose are illustrated in particular in FIG. 5, where suitable materials 44 such as sand, perlite, vermiculite, hydromulch, and the like are supplied from a storage hopper 43 to the substrate cord 2 in the region of the opening 9. For example, the storage hopper 43 may be designed in the manner of a funnel, which with its funnel neck is situated above the opening 9 and supplies the material 44 to the opening 9 or indentation 12. The storage hopper 43 optionally has a design that is lowerable onto the substrate cord 2 in order to reliably place and press the material 44 on the substrate cord 2. Devices suitable for this purpose correspond to those described in conjunction with the perforation device 11 or deposition device 14. A cover may also optionally be fixed above the opening 9, for example by gluing.

If the substrate cord 2, provided with seeds 13 in this manner, is to be used to plant a plant culture without a time delay, moisture is supplied to the substrate cord 2 in a subsequent, optional processing station. The irrigation device 17 illustrated in FIGS. 1 and 2, in which the substrate cord 2 is sprayed or sprinkled with water or led through an irrigation bath, is used for this purpose. Growth-promoting substances and/or plant protection agents may be admixed with the water.

In contrast, if storage of the substrate cord 2 provided with seeds 13 is intended over an extended time period, the substrate cord 2 may be dried in an optional processing station, not illustrated in greater detail, to prevent germination of the seeds.

The working cycles of the above-described processing stations, in particular the perforation device 10 and the deposition device 14, are coordinated with one another with the aid of synchronizer. This ensures that the seeds 13 are actually deposited in the openings 9, and that a problem-free production process subsequently takes place.

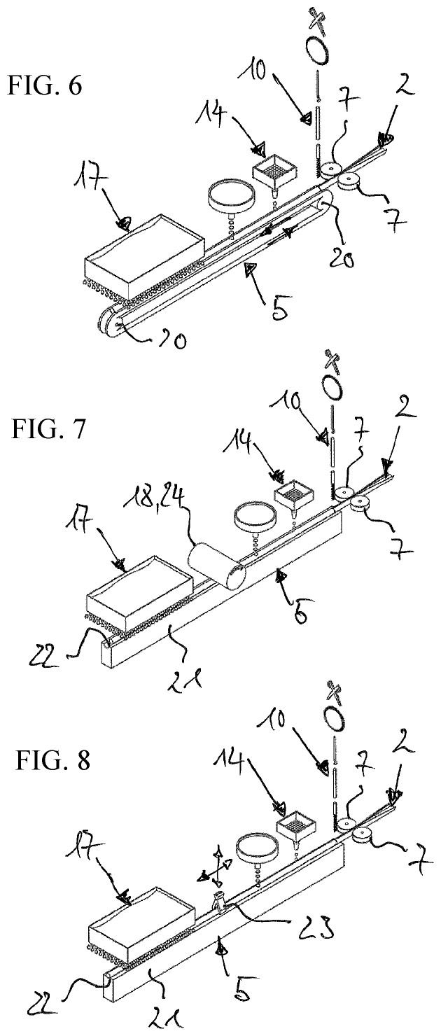

In addition to the conveying device 5 shown in FIGS. 1 through 5, in the form of a roller conveyor with at least one driven pair of rollers 7, further embodiments, described in greater detail with reference to FIGS. 6 through 8, lie within the scope of the invention. The conveying device 5 according to FIG. 6 has an endless conveyor belt 19 that is guided via deflection rollers 20 situated on the end side, at least one of the deflection rollers being driven for advancing the endless conveyor belt 19. The side of the endless conveyor belt 19 facing the substrate cord 2 has a cross-sectional contour corresponding to a portion of the cross-sectional contour of the substrate cord 2. In this way, the substrate cord 2 over its lower half is received and taken along by the endless conveyor belt 19 in a form-fit manner. The endless conveyor belt 19 thus forms an actively circulating conveyor channel that increases the conveyor safety and conveyor accuracy.

In the embodiment of the conveying device 5 illustrated in FIG. 7, the conveyor channel is formed by a stationary rail-like component 21 whose top side has a conveying groove 22 extending coaxially with respect to the axis 1, the cross section of the conveying groove for receiving the substrate cord 2 once again corresponding to approximately one-half the circumference of the substrate cord 2. The advancement of the substrate cord 2 is provided by at least one roller 24 which rests on the substrate cord 2 with pressure, and which due to its rotation advances the substrate cord 2 in the conveying groove 22. The roller 24 may have a profiled circumferential surface for better force transmission. To reduce the friction between the substrate cord 2 and the conveying groove 22, it is advantageous to provide the conveying groove 22 at its upper surface with a sliding layer, for example a sliding layer made of or containing polytetrafluoroethylene or polyoxymethylene. This embodiment is characterized by a simple and cost-effective design.

As is apparent from FIG. 8, instead of the at least one roller 24 the conveying device 5 may have one or more grippers 23 that are lowered onto the substrate cord 2 in a clocked manner, grip the substrate cord 2, advance it in the axial direction, release the contact with the substrate cord 2, and return to the starting position for a new cycle. The crossed double arrows symbolize the corresponding machine components such as cylinder piston units, linear drives, and the like.

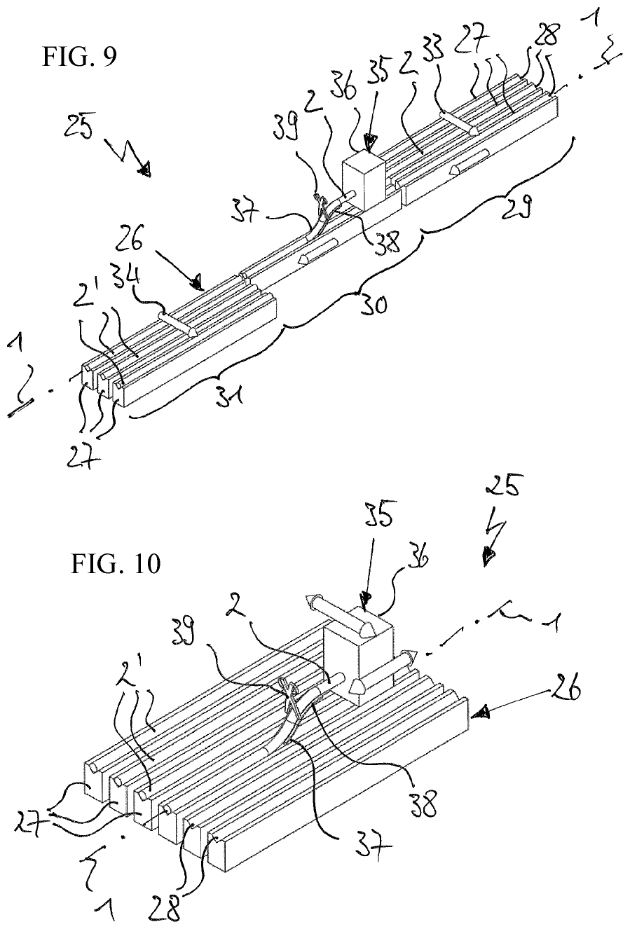

After traveling past the perforation device 13 and deposition device 14, the substrate cord 2 prepared with seeds 13 is made up of a continuous cord. In the course of the further processing, this continuous cord is converted into separate substrate cord sections 2′ by division and separation, as explained in greater detail below with reference to FIGS. 9 through 12. The length of the individual substrate cord sections 2′ may vary within a wide range, depending on the planned use. For example, the substrate cord sections 2′ for producing plant stumps may have a length between 10 cm and 20 cm; in contrast, for planting large-area field crops, the length of the substrate cord section 2′ may even be several meters, which is then preferably rolled onto reels.

FIG. 9 shows a schematic view of a first embodiment of an apparatus 25 that is suitable for the purpose of cutting a substrate cord 2 to size and separating the cut-to-length substrate cord sections 2′. A receiving unit 26 having a plurality of strip-shaped receiving elements 27, which at their top side each have a receiving groove 28 that extends over the entire length of the receiving element 27, is apparent. The receiving unit 26 is divided, in the movement direction 6 of the substrate cord 2, into a first area 29 with empty receiving elements 27, a second area 30 where the receiving elements 27 are filled with the substrate cord 2, and a third area 31 in which the receiving elements 27 with inserted substrate cord sections 2′ are separated. In all areas 29, 30, and 31, the individual receiving elements 27 are situated axially parallel to the axis 1. The movement direction of the receiving elements 27 in the areas 29, 30, and 31 is indicated by arrows.

The receiving elements 27 in the first area 29 are displaceable transversely with respect to the axis 1, for example horizontally or vertically, to allow each receiving unit 27 to be brought into a position that is aligned with the longitudinal axis 1 of the substrate cord 2. In the course of the subsequent displacement of this receiving element 27 in the direction of the axis 1, at a speed corresponding to the advancement speed of the substrate cord 2 in the upstream area, the substrate cord 2 in the second area 30 is inserted into the receiving groove 28 of the receiving element 27. The gap in the first area 29 that becomes free after completion of this operation is filled by a receiving element 27 which moves up in the transverse direction 33, and which in this train now assumes a position that is aligned with the axis 1. During the deposition operation in the second area 30, the receiving element 27 gradually moves forward along the axis 1 in the direction of the third area 31 of the receiving unit 26, where sufficient room for the receiving element 27 to move up has been provided by a movement 34, transverse to the axis 1, of the receiving units 27 already filled with substrate cord sections 2′. After the deposition operation in the second area 30 ends, the substrate cord 2 is cut to length by use of a cutting edge unit 39.

Depositing the substrate cord 2 into the receiving groove 28 of a receiving element 27 takes place with the aid of a laying device 35 situated in the second area 30. The laying device 35 has a laying head 36 that is stationary with respect to the device, and a laying head end 37. The laying head 36 and laying head end 37 are rigidly connected to one another via a substrate cord guide 38. The continuous substrate cord 2 coming from the conveying unit 5 is supplied to the laying head 36 in the direction of the axis 1, and is led via the substrate cord guide 38 to the laying head end 37. The laying head end 37 is positioned directly above the receiving groove 28 of the receiving element 27, so that the substrate cord 2 exiting from the laying head end 37 is gradually laid into the receiving groove 28 of the receiving element 27 moving under the laying head end 37 in the direction 6. When the receiving groove 28 is filled over its entire length, the substrate cord section 2′ is separated from the substrate cord 2 by use of a cutting device 39.

FIG. 10 relates to an embodiment of a device according to the invention in which the apparatus 25 for cutting the substrate cord 2 to length and separating the cut-to-length substrate cord sections 2′ has a stationary receiving unit 26 with a plurality of adjacent, axially parallel receiving elements 27. The receiving grooves 28 of the receiving elements 27 are oriented in parallel to the axis 1. The laying head 36 together with the laying head end 37, as symbolized by the arrows, is displaceably supported and driven in the axis 1 as well as transversely thereto, and for depositing a substrate cord 2 moves above and along the receiving groove 28 of a receiving element 27. After the end of a receiving element 27 is reached, the substrate cord 2 is cut off using the cutting device 39, and the laying head 36 is moved transversely to the start of the next receiving element 27, where the deposition operation begins anew.

The subject matter of FIG. 11 is an embodiment in which the laying head end 37 is integrated into a laying car 40, and the stationary or movable laying head 36 and the laying head end 37 are connected to one another via a flexible substrate cord guide 41. According to the invention, there is an option for a receiving unit 26 with a number of receiving elements 27, as described with respect to FIG. 10, to be stationarily situated, and for the laying car 40 to be initially moved in the direction of the axis 1 in order to lay the substrate cord 2 into a receiving groove 28, and after the laying operation is completed and the substrate cord 2 is cut to length using the cutting device 39, to be subsequently repositioned transversely with respect to the axis 1 in order to insert the substrate cord 2 into the receiving groove 28 of a neighboring receiving element 27.

Alternatively, it is possible for the laying car 40 to be movable only in the direction of the axis 1, and for the change to the next receiving element 27 to take place by moving crosswise over the receiving unit 26.

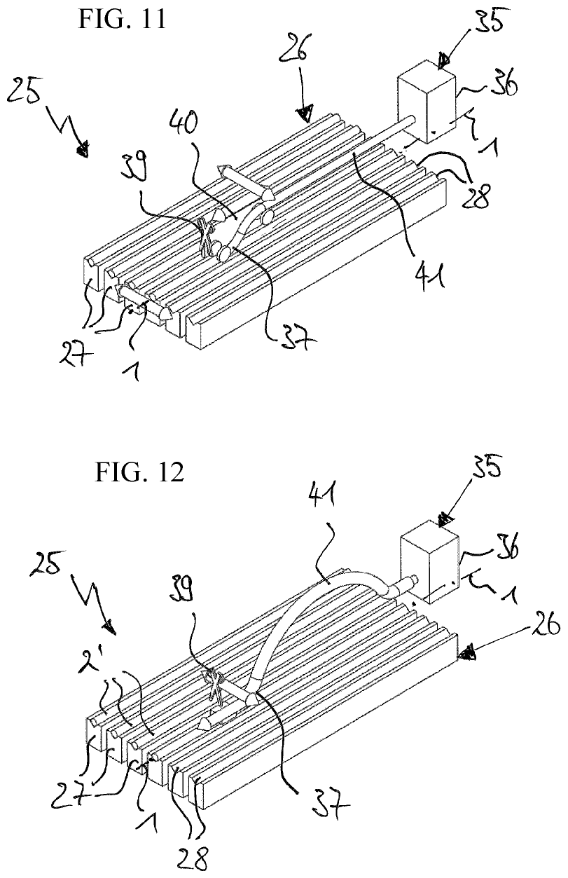

Lastly, FIG. 12 shows an embodiment in which the stationary or movable laying head 36 and the laying head end 37 are spaced apart and connected to one another via a flexible substrate cord guide 41. In contrast to the embodiment according to FIG. 11, however, the laying head end 37 is moved by a robotic arm, not illustrated, along the receiving grooves 28 of the receiving elements 27. For this purpose, the robotic arm has multiple degrees of freedom, preferably six degrees of freedom, symbolized by the crossed arrows, and is controlled by an electronic control unit. The actuation of the receiving units is thus freely programmable, so that arbitrary receiving units may be filled with a substrate cord in any given order.

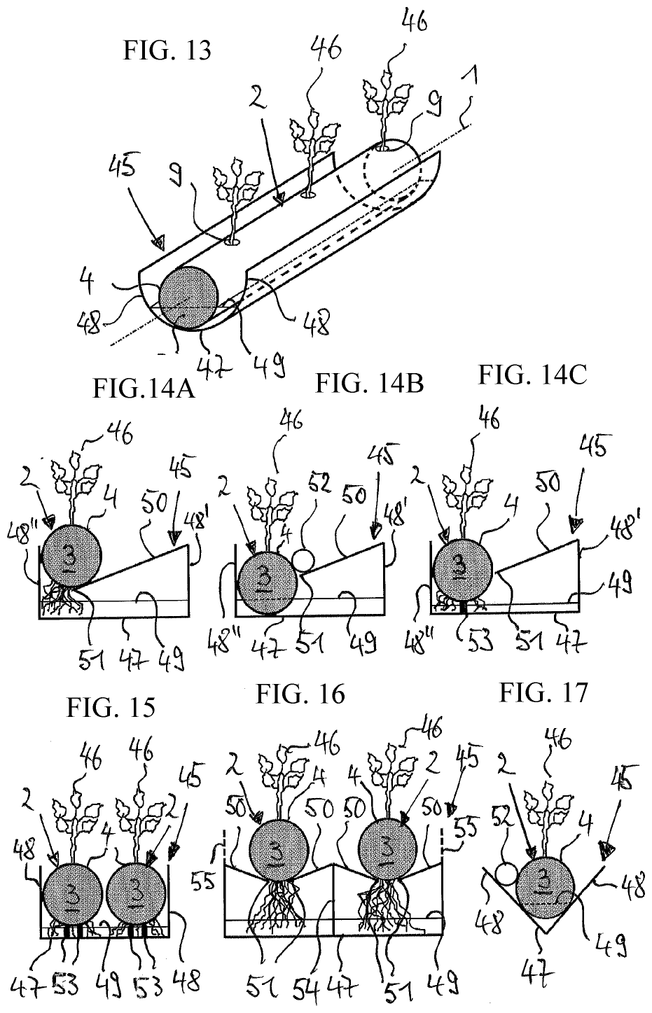

The subject matter in FIGS. 13 through 17 relates to various embodiments of a system according to the invention in which a substrate cord 2 is situated in a gutter 45. In the embodiment illustrated in FIG. 13, only a longitudinal section is illustrated as representative of a substrate cord 2 having an arbitrary length. The substrate cord 2 is made up essentially of a sheath 4 and a plant substrate 3 situated inside the sheath 4. In the area of the upper crown, openings 9 are introduced at regular intervals into the sheath 4, through which a seed has been planted in the plant substrate 3 in each case. The plants that have emerged from a seed are denoted by reference numeral 46, and the longitudinal axis of the substrate cord 2 is denoted by reference numeral 1. The substrate cord 2 rests in a gutter 45 whose curved gutter base 47 and curved gutter longitudinal walls 48 merge into one another, resulting in a semicircular cross section of the gutter 45 that is open at the top. The gutter 45 extends axially parallel to the longitudinal axis 1. The length of the gutter 45 is arbitrary, it being possible for the end-face ends to be closed off in each case by a cover, not illustrated. The gutter 45 is made of a liquid-tight material to allow water 49 to be received or guided for irrigation of the plant substrate 3. For this purpose, the gutter 45 is preferably equipped with a water inlet and/or water outlet, not illustrated in greater detail.

FIGS. 14A through 14C each show a cross section of various embodiments of the system according to the invention, the cross sections of the gutter 45 being different. All embodiments share the feature that a gutter 45 with a planar gutter base 47, at whose two longitudinal edges upright, likewise planar, gutter longitudinal walls 48′, 48″ project in each case. A retaining element 50, likewise having a flat design, is fastened with its corresponding longitudinal edge along the upper edge of a first gutter longitudinal wall 48′. With its oppositely situated free longitudinal edge 51, the retaining element 50 points in the direction of the oppositely situated second gutter longitudinal wall 48″ while maintaining a free distance from the second gutter longitudinal wall 48″. In addition, the retaining element 50 is inclined in such a way that the distance of the free longitudinal edge 51 from the gutter base 47 is less than the distance of the oppositely situated longitudinal edge, used for fastening to the first gutter longitudinal wall 48′, from the gutter base 47. The retaining element 50 thus forms a slope which, together with the second gutter longitudinal wall 48″, forms a receptacle, extending in the direction of the axis 1, for a substrate cord 2. The substrate cord is fixed in position by the retaining element 50 and the second gutter longitudinal wall 48″.

In the embodiment according to FIG. 14A, the substrate cord 2 is held at a distance from the gutter base 47; the root system of the plants 46 that develops over time grows toward the base 47, between the free longitudinal edge 51 of the retaining element 50 and the second gutter longitudinal wall 48″, and receives the water 49 that is present there.

In contrast, the embodiment according to FIG. 14B provides a distance of the free edge 51 of the retaining element 50 from the second gutter longitudinal wall 48″, corresponding approximately to the dimensions of the substrate cord 2. As a result, the substrate cord 2 may be deposited on the gutter base 47 of the gutter 45, while the substrate cord is laterally supported by the second gutter longitudinal wall 48″ and the free edge 51 of the retaining element 50. The substrate cord 2 with its lower portion immerses in the water 49 supplied from the gutter 45. Additionally or alternatively, an irrigation tube 52 may be inserted into the gutter 45 for irrigation. In FIG. 14B, the irrigation tube 52 rests on the retaining element 50, in contact with the substrate cord 2, but could also be situated in the wedge area between the substrate cord 2 and the second gutter longitudinal wall 48″, or on the base 47.

The embodiment according to FIG. 14C corresponds to a great extent to that described with reference to FIG. 14B, so that the statements provided there correspondingly apply. There are differences in the region of support of the substrate cord 2, which rests on a support element 53 for maintaining a distance from the gutter base 47. In the present case the support element 53 is designed in the manner of a bar that extends over the entire length of the gutter 45 in parallel to the axis 1. A support element 53 formed by a plurality of pins lined up in a row would likewise be conceivable. In this embodiment the substrate cord 2, with a clearance with respect to the base 47, is fixed in position by the free edge 51 of the retaining element, the second gutter longitudinal wall 48″, and the support element 53.

In the gutters 45 according to FIGS. 14A through 14C, the retaining elements 50 together with the particular substrate cord 2 prevent light from striking the interior of a gutter 45. Algae growth in a gutter 45 is thus essentially completely prevented, and cleaning of a gutter 45 is subsequently facilitated.

FIG. 15 shows an embodiment in which the gutter 45, corresponding to the above-described embodiments, has a planar gutter base 47 with upright gutter longitudinal walls 48, but without an additional retaining element. The spacing of the gutter longitudinal walls 48 is dimensioned in such a way that exactly two substrate cords 2 fit between the gutter longitudinal walls 48, each of which supports the outer side of a substrate cord 2. The substrate cords 2 support one another at the mutually facing inner sides. For maintaining a distance from the gutter base 47, support elements 53 are once again situated at the gutter base 47, and in each case in two parallel rows support a substrate cord 2 in the gutter 45 above the water level 49.

The spacing of the gutter longitudinal walls 48 may also be dimensioned in such a way that more or fewer substrate cords 2 fit next to one another in the gutter 45.

FIG. 16 relates to an embodiment in which the gutter 45 is likewise intended for accommodating two substrate cords 2. For this purpose, the area between the gutter base 47 and the two gutter longitudinal walls 48 is divided by a partition wall 54. In each case retaining elements 50 protrude from the free longitudinal edges of the two gutter longitudinal walls 48 and the partition wall 54, analogously to the situation described with reference to FIGS. 14a through 14c, the inclination of the retaining elements extending in such a way that in each case an outer retaining element 50 together with an inner retaining element 50 forms a funnel-like receptacle for a substrate cord 2. The free longitudinal edges 51 of the retaining elements 50 of such a funnel-shaped receptacle maintain a mutual clearance, so that a longitudinal gap is formed. When a substrate cord 2 is inserted, it is automatically centered above the longitudinal gap due to the opposite slopes of the retaining elements 50. The developing root system of the plants 46 may thus grow through the longitudinal gap in the direction of the base 47, and may be supplied with water 49 at that location.

It is understood that the embodiment shown in FIG. 16 may also have multiple partition walls 54, resulting in multiple receptacles for more than two substrate cords 2, or may have no partition wall, so that only a single funnel-shaped receptacle results between the side walls 48 in combination with the retaining elements 50. As also indicated by the dashed lines 55, the gutter longitudinal walls 48 may be guided across the fastening edge of a retaining element 50 to prevent a substrate cord 2 from inadvertently rolling off from the gutter 45.

The embodiment according to FIG. 17 is characterized by a gutter 45 having a V-shaped cross section that opens at the top. For this purpose, the gutter base 47 of the gutter 45 has an angular design with two legs, which are adjoined by the gutter longitudinal walls 48. This results in a receptacle, having a funnel-shaped cross section, in which the substrate cord 2 rests, and the substrate cord is fixed in position between the oppositely sloped gutter longitudinal walls 48 or legs of the gutter base 47.

For irrigation of the plants 46, the gutter 45 is partially filled with water 49, into which the substrate cord 2 is immersed. Additionally or alternatively, for the irrigation an irrigation tube 52 may be inserted into the gutter 45, preferably in the wedge area between the substrate cord 2 and one or both gutter longitudinal walls 48.

A system according to the invention, with multiple adjacent substrate cords 2, results from the arrangement and connection of multiple gutters 45, having a V-shaped cross section, next to one another.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for introducing seeds or seedlings into a tube-like substrate cord that is enclosed by a sheath that is filled with a plant substrate, the device comprising:
a conveying device to convey the substrate cord in a direction of its longitudinal axis continuously, without interruption or in a clocked manner;
a perforation device with a perforation tool, the perforation tool being transaxially lowerable onto the substrate cord for creating openings in the sheath; and
a deposition device with a deposition tool, the deposition tool introducing one or more seeds or seedlings into the plant substrate through an opening created by the perforation device.

2. The device according to claim 1, wherein the perforation tool is designed to create an indentation in the plant substrate in the area of the opening.

3. The device according to claim 1, wherein the perforation tool has at least one cutting edge or one cutting edge and one counter cutting edge, for creating openings in the sheath.

4. The device according to claim 1, wherein the perforation tool for creating openings in the sheath has a punching knife or scissors.

5. The device according to claim 1, wherein the perforation tool for creating openings in the sheath has a saw with at least one rotating circular knife.

6. The device according to claim 1, wherein the perforation tool for creating openings in the sheath has a ripping tool that is engageable with the sheath.

7. The device according to claim 1, wherein the perforation tool for creating openings in the sheath has a borer that is lowerable onto the substrate cord.

8. The device according to claim 1, wherein the deposition device has a separation and metering unit from which the seeds are individually suppliable to the deposition tool.

9. The device according to claim 1, wherein the deposition tool is adapted to be transaxially lowerable onto the substrate cord.

10. The device according to claim 1, wherein the deposition tool has a deposition tube that is situated above the opening or in the opening at the time the seed is introduced.

11. The device according to claim 1, wherein the device has a cover for closing the opening and/or indentation in the substrate cord.

12. The device according to claim 1, wherein the device has a pressing element that is lowerable onto the opening or indentation in the substrate cord which is loaded with a seed.

13. The device according to claim 1, wherein the conveying device includes a guide channel and advancer for conveying the substrate cord.

14. The device according to claim 13, wherein the guide channel is formed by elements that are moved in the conveying direction by a roller conveyor and/or a conveyor belt.

15. The device according to claim 13, wherein the guide channel is formed by a stationary conveying groove.

16. The device according to claim 13, wherein the advancer is formed by driven rollers, or grippers.

17. The device according to claim 1, wherein the device includes a synchronizer via which the working cycle of the perforation device and the working cycle of the deposition device and the conveying speed are coordinatable with one another.

18. The device according to claim 1, wherein the device has a supplier to supply liquid or moisture to the substrate cord.

19. The device according to claim 1, wherein the device has a dryer to dry the substrate cord.

20. The device according to claim 1, wherein the device has a unit for cutting the substrate cord length and separating the to-length substrate cord sections, the unit including receiving elements for the substrate cord and a laying head with a laying head end, the substrate cord being suppliable to the laying head and depositable in the receiving elements via the laying head end.

21. The device according to claim 20, wherein the laying head is stationarily situated with respect to the device, and the receiving elements are designed to be longitudinally and/or transversely displaceable with respect to the substrate cord longitudinal axis.

22. The device according to claim 20, wherein the laying head is designed to be longitudinally and/or transversely displaceable with respect to the substrate cord longitudinal axis, and the receiving elements are stationary.

23. The device according to claim 20, wherein the laying head and the laying head end are connected via a flexible substrate cord guide, and the laying head end is movable longitudinally and/or transversely displaceable with respect to the substrate cord longitudinal axis by use of a laying car or a robotic arm.

24. A method for introducing seeds or seedlings into a tube-like substrate cord that is enclosed by a sheath that is filled with a plant substrate, the method comprising:
providing the tube-like substrate cord with the plant substrate and the sheath;
creating an opening in the sheath at a predetermined location; and
depositing at least one seed or at least one seedling into the opening.

25. The method according to claim 24, wherein an indentation is created in the plant substrate below the opening.

26. The method according to claim 24, wherein the at least one seed or the at least a seedling is pressed into the plant substrate with the deposition or after the deposition.

27. The method according to claim 24, wherein the opening and/or indentation are/is closed.

28. The method according to claim 24, wherein the substrate cord is irrigated or dried.

29. A substrate cord including a sheath and a plant substrate arranged inside the sheath, at least one seed or at least one seedling being arranged in the plant substrate, wherein the sheath has at least one opening, and the at least one seed or the at least one seedling is arranged in or on the plant substrate transversely with respect to the longitudinal axis of the substrate cord behind the opening.

30. A system for cultivating plants, comprising at least one substrate cord that is enclosed by a sheath, and the space within the sheath is filled with a plant substrate into which seeds or plants are inserted, wherein the system includes at least one gutter that is open at the top and is suppliable with water for irrigating the seeds or plants, the at least one substrate cord being situated in the at least one gutter.

31. The system according to claim 30, wherein the at least one gutter has a gutter base and two gutter longitudinal walls, the at least one substrate cord resting on the gutter base, between the gutter longitudinal walls.

32. The system according to claim 30, wherein the at least one gutter has a gutter base and two gutter longitudinal walls, wherein at least one support element is arranged at the gutter base between the gutter longitudinal walls, and wherein the at least one substrate cord rests on the at least one support element at a distance from the gutter base.

33. The system according to claim 31, wherein a retaining element is arranged at at least one gutter longitudinal wall and the at least one substrate cord is held or supported by the retaining element.

34. The system according to claim 31, wherein the gutter base and the gutter longitudinal walls have a curved cross section for forming a partially circular gutter cross section.

35. The system according to claim 31, wherein the gutter base and the gutter longitudinal walls have a planar cross section for forming a polygonally shaped gutter cross section.
